(19) United States
(12) Patent Application Publication
(10) Pub. No.: US 2013/0193229 A1
(43) Pub. Date: Aug. 1, 2013

(54) THERMAL SPRAY COMBUSTION GUN WITH A TOLERANCE COMPENSATION SPRING

(71) Applicant: Martin E. HACKER, Westbury, NY (US)

(72) Inventor: Martin E. HACKER, Westbury, NY (US)

(73) Assignee: SULZER METCO (US) INC., Westbury, NY (US)

(21) Appl. No.: 13/360,189

(22) Filed: Jan. 27, 2012

(51) Int. Cl. B05B 1/24; B21D 51/16

(52) U.S. Cl. 239/135; 29/890.09

(57) ABSTRACT

A thermal spray combustion gun including a burner assembly, a combustion chamber assembly, a middle gun body, and a spring. The spring is structured and arranged to provide a spring force that maintains a first metal-to-metal seal between the burner assembly and the combustion chamber assembly, and maintains a second metal-to-metal seal between the combustion chamber assembly and the middle gun body.

### BACKGROUND OF THE INVENTION

1. Field of the Invention

The present invention is directed to an improved thermal spray combustion gun.

2. Description of the Related Art

Thermal spraying techniques are coating processes in which melted (or heated) materials are sprayed onto a surface. With a thermal spray combustion gun, the “feedstock” (coating precursor) is heated by a chemical process (e.g., a combustion flame). Thermal spraying can provide thick coatings (for example, 20 micrometers to several mm, depending on the process and feedstock), over a large area at high deposition rate as compared to other coating processes such as electroplating, physical and chemical vapor deposition. Coating materials available for thermal spraying include metals, alloys, ceramics, plastics and composites. The coating materials may be fed in powder or wire form, heated to a molten or semi-molten state and accelerated towards substrates in the form of micrometer-size particles. Resulting coatings are made by the accumulation of numerous sprayed particles.

A thermal spray system generally includes the following components: (1) a spray torch (or spray gun)—the core device performing the melting and acceleration of the particles to be deposited; (2) a feeder—for supplying the powder, wire or liquid to the torch; (3) a media supply—gases or liquids for the generation of the flame or plasma jet, gases for carrying the powder, etc.; (4) a robot—for manipulating the torch or the substrates to be coated; (5) a power supply—often standalone for the torch; and (6) a control console(s)—either integrated or individual for all of the above.

A conventional thermal spray combustion gun may include a long water cooled barrel with inlet valves for gases and powder. Oxygen and fuel (acetylene most common) is fed into the barrel along with a charge of powder. A spark is used to ignite the gas mixture and the resulting detonation heats and accelerates the powder to supersonic velocity down the barrel. A pulse of nitrogen may be used to purge the barrel after each detonation. This process is repeated many times a second. The high kinetic energy of the hot powder particles on impact with the substrate result in a build up of a very dense and strong coating.

With high velocity oxy-fuel spraying, a mixture of gaseous or liquid fuel and oxygen is fed into a combustion chamber, where they are ignited and combusted continuously. The resultant hot gas at a pressure close to 1 MPa emanates through a converging-diverging nozzle and travels through a straight section. The fuels can be gases (hydrogen, methane, propane, propylene, natural gas, etc.) or liquids (kerosene, etc.). The jet velocity at the exit of the barrel (>1000 m/s) exceeds the speed of sound. A powder feed stock is injected into the gas stream, which accelerates the powder up to 800 m/s. The stream of hot gas and powder is directed towards the surface to be coated. The powder partially melts in the stream, and deposits upon the substrate. The resulting coating has low porosity and high bond strength.

Combustion spraying guns use oxygen and fuel gases (e.g., kerosene). The fuel gases are potentially explosive. Oxygen, while not explosive, will sustain combustion, and many materials will spontaneously ignite, if excessive oxygen levels are present. Thus, care must be taken to avoid leakage, and to isolate oxygen and fuel gas supplies, when not in use.

Therefore, there is a need for and improved thermal spray combustion gun.

### SUMMARY OF THE INVENTION

Within the spray gun, a burner assembly, a combustion chamber and a middle gun body are metal components (e.g., copper), which are subjected to high thermal pressures and thermal expansion during operation. Rubber o-ring seals, for example, between these components, however, may not withstand the high temperatures endured in the spray gun. Thus, in accordance with aspects of the invention, in order to prevent hot gasses from escaping (e.g., from the combustion chamber) to other areas of the spray gun, metal-to-metal seals are maintained between the burner assembly, the combustion chamber and the middle gun body.

Fixedly attaching (e.g., via threaded connections) adjacent elements in the spray gun has drawbacks, in that the fixedly attached connections may be subject to excessive forces and/or failure upon thermal expansion. That is, the threaded connections (e.g., bolts) between, for example, the burner assembly and the combustion chamber would not allow for any expansion between these components, thus possibly resulting in damage and/or failure to the threaded connection and/or these components upon thermal expansion.

In embodiments, the present invention provides a thermal spray combustion gun, in which adjacent elements of the spray gun (e.g., the burner assembly, the combustion chamber and the middle gun body) are provided with manufacturing tolerances designed to accommodate some of the thermal expansion and contraction. These manufacturing tolerances, however, may leave gaps between adjacent elements of the spray gun, such that combustion gases could escape into other parts of the thermal spray gun. As such, in accordance with additional aspects of the present invention, the manufacturing tolerance on the components is selected such that a gap is provided at a spring location, and a spring is provided in the gun at the spring location (e.g., in the spring seat) to exert a force on the burner assembly. In accordance with aspects of the invention, this spring force maintains the respective metal-to-metal seal between the burner assembly and the combustion chamber, and between the combustion chamber and the middle gun body. In other words, the spring compensates for the tolerances of the burner assembly, the combustion chamber, and the middle gun body, to maintain the respective metal-to-metal seals.

In accordance with additional aspects of the invention, in embodiments, the spring comprises a compression spring. In accordance with additional aspects of the invention, in embodiments, the spring comprises a crest-to crest wave spring.

By implementing aspects of the present invention, metal-to-metal seals are maintained between the burner assembly, the combustion chamber and the middle gun body to prevent hot gasses from escaping (e.g., from the combustion chamber) to other areas of the spray gun. Additionally, by implementing aspects of the present invention, the compression spring allows for thermal expansion within the combustion chamber (e.g., some relative movement between the burner assembly and the combustion chamber assembly and/or between the combustion chamber assembly and the middle gun body), while still maintaining a good seal (e.g., a metal-to-metal seal) between these respective elements.

In embodiments, a thermal spray combustion gun comprises a burner assembly; a combustion chamber assembly; a middle gun body; and a spring, wherein the spring is structured and arranged to exert a spring force that maintains a first metal-to-metal seal between the burner assembly and the combustion chamber assembly, and maintains a second metal-to-metal seal between the combustion chamber assembly and the middle gun body.

In additional embodiments, the thermal spray combustion gun further comprises a gun body subassembly having a spring seat, wherein the spring is structured and arranged within the spring seat and in contact with the burner assembly.

In further embodiments, the burner assembly is arranged adjacent to the combustion chamber assembly at a first end of the combustion chamber assembly, and wherein the middle gun body is arranged adjacent to the combustion chamber assembly at a second end of the combustion chamber assembly.

With additional embodiments, the spring is structured and arranged to exert the spring force on the burner assembly.

In embodiments, the spring comprises a compression spring.

In further embodiments, the spring comprises a crest-to crest wave spring.

In additional embodiments, the burner assembly, the combustion chamber, and the middle gun body are structured and arranged having respective manufacturing tolerances such that a gap is provided at a spring location in which the spring is arranged.

In embodiments, the spring is structured and arranged to exert the spring force in an axial direction against the burner assembly, which urges the burner assembly towards a front of the thermal spray combustion gun to maintain the first metal-to-metal seal between the burner assembly and the combustion chamber assembly at one or more contact surfaces.

In further embodiments, through contact of the burner assembly with the combustion chamber assembly at the one or more contact surfaces, the spring force is transmitted in the axial direction through the combustion chamber assembly, to maintain the combustion chamber assembly in contact with the middle gun body at one or more second contact surfaces to maintain the second metal-to-metal seal between the combustion chamber assembly and middle gun body at the one or more second contact surfaces.

In embodiments, the first metal-to-metal seal between the burner assembly and the combustion chamber assembly is operable to prevent gas from escaping from a back end of the combustion chamber assembly at the one or more contact surfaces.

In further embodiments, the second metal-to-metal seal between the combustion chamber assembly and the middle gun body is operable to prevent gas from escaping from a front end of the combustion chamber assembly at the one or more second contact surfaces.

In further embodiments, the burner assembly, the combustion chamber assembly and the middle gun body each comprise a metal.

In embodiments, the metal comprises copper.

In additional embodiments, the spring comprises a stainless steel.

In further embodiments, the spring comprises a crest-to crest wave compression spring having two turns.

In embodiments, the spring comprises a crest-to crest wave compression spring having four waves per turn.

Embodiments of the present invention are directed to a method of assembling a thermal spray combustion gun, wherein the thermal spray combustion gun comprises: a burner assembly, a combustion chamber assembly; a middle gun body; a gun body subassembly having a spring seat; and a spring. The method comprises arranging the spring in the spring seat; arranging the burner assembly in the gun body subassembly in contact with the spring; arranging the combustion chamber assembly in the gun body subassembly in contact with the burner assembly; and attaching the middle gun body to the gun body subassembly, such that the middle gun body is in contact with the combustion chamber assembly. The spring is structured and arranged to exert a spring force that maintains a first metal-to-metal seal between the burner assembly and the combustion chamber assembly, and maintains a second metal-to-metal seal between the combustion chamber assembly and the middle gun body.

In additional embodiments, the spring comprises a crest-to crest wave compression spring.

In further embodiments, the spring is structured and arranged to exert the spring force in an axial direction against the burner assembly, which urges the burner assembly towards a front of the thermal spray combustion gun to maintain the first metal-to-metal seal between the burner assembly and the combustion chamber assembly at one or more contact surfaces.

In additional embodiments, through the contact of the burner assembly with the combustion chamber assembly at the one or more contact surfaces, the spring force is transmitted through the combustion chamber assembly, and maintains the combustion chamber assembly in contact with the middle gun body at one or more second contact surfaces to provide the second metal-to-metal seal between the combustion chamber assembly and middle gun body at the one or more second contact surfaces.

### BRIEF DESCRIPTION OF THE DRAWINGS

For a more complete understanding of the invention, as well as other objects and further features thereof, reference may be had to the following detailed description of the invention in conjunction with the following exemplary and non-limiting drawings wherein:

FIG. 1 illustrates an exemplary thermal spray combustion gun showing the location of the compression spring in accordance with aspects of the invention;

FIG. 2 illustrates an exemplary crest-to crest wave spring in accordance with aspects of the invention;

FIG. 3 illustrates another exemplary crest-to crest wave spring in accordance with aspects of the invention; and

FIG. 4 illustrates a top and side views of exemplary crest-to crest wave springs in accordance with aspects of the invention.

Reference numbers refer to the same or equivalent parts of the present invention throughout the various figures of the drawings.

### DETAILED DESCRIPTION OF THE INVENTION

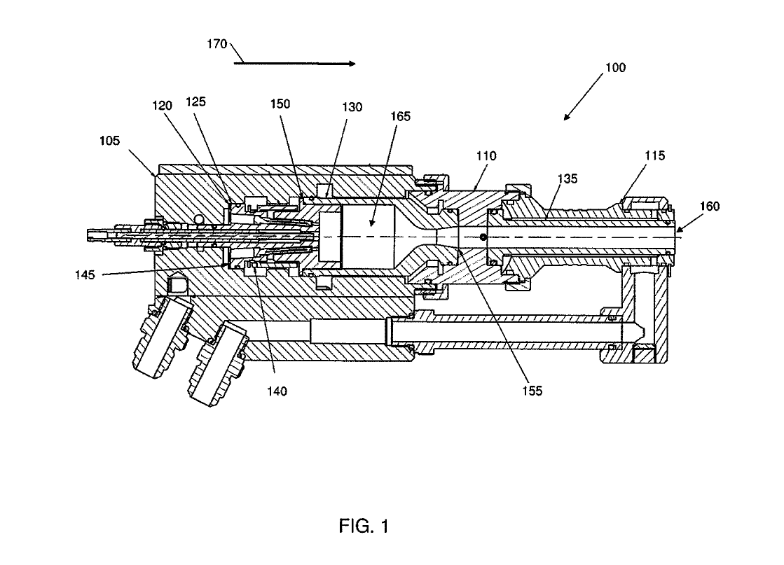

FIG. 1 illustrates an exemplary thermal spray combustion gun 100 showing the location of a compression spring 120 in accordance with aspects of the invention. As shown in FIG. 1, the thermal spray combustion gun 100 includes gun body subassembly 105, a middle gun body 110, and a front gun assembly 115. The gun body subassembly 105 accommodates therein, the burner assembly 125, the combustion chamber assembly 130, the compression spring 120, and an external ring 140, amongst other components of the thermal spray combustion gun 100.

As shown in FIG. 1, in embodiments, the gun body subassembly 105 includes a spring seat 145 to accommodate the compression spring 120 therein. The compression spring 120 is structured and arranged to exert an axially-directed force 170 against the burner assembly 125. The axially-directed force 170 urges the burner assembly 125 towards the front 160 of the thermal spray combustion gun 100. Moreover, in accordance with aspects of the invention, the axially-directed force 170 urges the burner assembly 125 into contact with the combustion chamber assembly 130 at one or more contact surfaces 150 to provide a metal-to-metal seal. In accordance with aspects of the invention, by maintaining the metal-to-metal seal between the burner assembly 125 and the combustion chamber assembly 130, hot gasses, for example, are prevented from escaping from a back side of the combustion chamber 165, e.g., at the one or more contact surfaces 150.

Additionally, through the contact of the burner assembly 125 with the combustion chamber assembly 130 at the one or more contact surfaces 150, the axially-directed force 170 is transmitted through the combustion chamber assembly 130, and urges the combustion chamber assembly 130 into contact with the middle gun body 110 at one or more second contact surfaces 155 to provide a metal-to-metal seal. In accordance with aspects of the invention, by maintaining a metal-to-metal seal between the combustion chamber assembly 130 and the middle gun body 110, hot gasses, for example, are prevented from escaping from a front side of the combustion chamber 165, e.g., at the one or more second contact surfaces 155.

During operation, the burner assembly 125, the combustion chamber assembly 130 and the middle gun body 110 are subjected to high thermal pressures and thermal expansion. By implementing aspects of the present invention, metal-to-metal seals may be maintained between the burner assembly 125 and the combustion chamber assembly 130, and between the combustion chamber assembly 130 and the middle gun body 110 to prevent hot gasses from escaping (e.g., from the combustion chamber 165) to other areas of the spray gun.

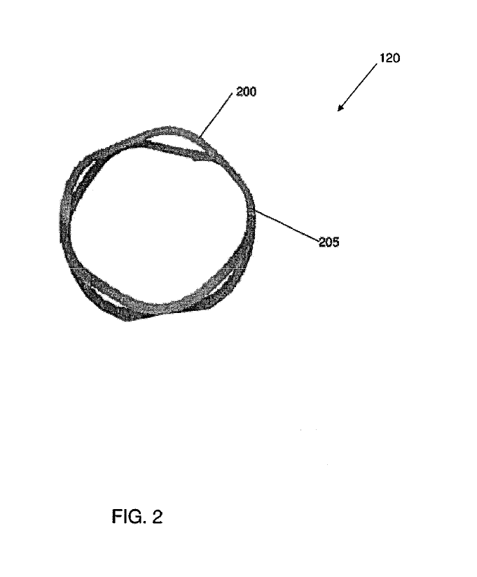

FIG. 2 illustrates an exemplary non-limiting crest-to crest wave compression spring 120 in accordance with aspects of the invention. In embodiments, the crest-to crest wave compression spring 120 is a SPIRAWAVE® compression spring. (SPIRAWAVE is a registered trademark of Smalley Steel Ring Company Corp. in the United States.) With a non-limiting exemplary embodiment, the compression spring comprises a 17-7 pH stainless steel, and has an outside diameter of approximately 1.277 inches and an inside diameter of approximately 1.153 inches. The compression spring is structured to clear a 0.919 inch shaft diameter. Additionally, the exemplary compression spring 120 comprises a free height of approximately 0.146 inches to 0.166 inches, a 16.8 pounds of force at a 0.060 inch work height and a 20.3 pounds of force at a 0.040 inch work height.

In embodiments, the spring seat 145 (shown in FIG. 1) has a bore diameter of approximately 1.310 inches, so as to support the compression spring 120 having an outside diameter of approximately 1.277 inches.

As illustrated in FIG. 2, the crest-to crest wave spring 120 comprises a single wave spring element 200 having a first end 205 and a second end (not shown). As shown in FIG. 2, the exemplary crest-to crest wave compression spring 120 includes two turns. That is, the single wave spring element 200 comprises approximately two full turns between the first end 205 and the second end (not shown). While the exemplary embodiment of FIG. 2 illustrates a crest-to crest wave spring having two turns, the invention contemplates a crest-to crest wave spring having more or less turns.

Additionally, as shown in FIG. 2, the exemplary crest-to crest wave compression spring 120 includes four waves per turn. The invention, however, contemplates a crest-to crest wave spring having more or less waves per turn. That is, through each turn, the spring 120 includes four waves (or respective crests and valleys).

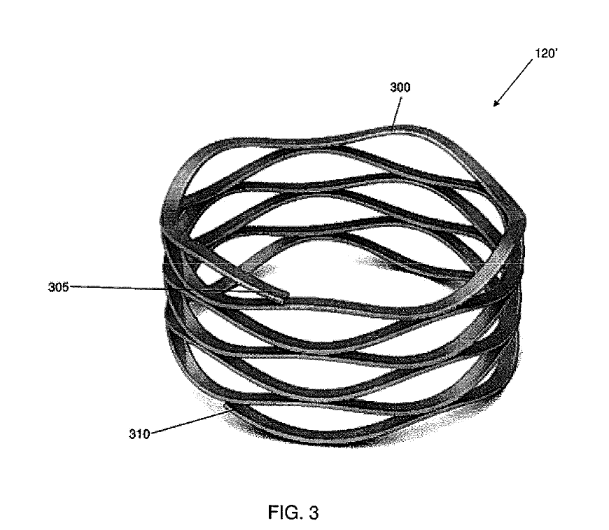

FIG. 3 illustrates another exemplary non-limiting crest-to crest wave spring 120′ in accordance with aspects of the invention. As illustrated in FIG. 3, the crest-to crest wave spring 120′ comprises a single wave spring element 300 having a first end 305 and a second end 310. As shown in FIG. 3, the exemplary crest-to crest wave compression spring 120′ includes six turns. That is, the single wave spring element 300 comprises approximately six full turns between the first end 305 and the second end 310. Additionally, as shown in FIG. 3, the exemplary crest-to crest wave compression spring 120′ includes approximately five waves per turn. The invention, however, contemplates a crest-to crest wave spring having more or less turns and/or more or less waves per turn.

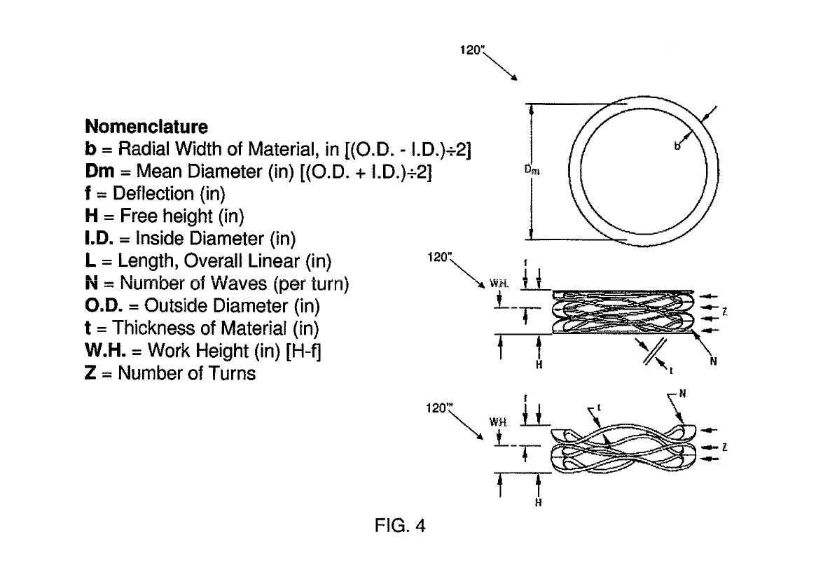

FIG. 4 illustrates a top and side views of exemplary crest-to crest wave springs in accordance with aspects of the invention. As shown in FIG. 4, a crest-to crest wave spring may be configured in accordance with a plurality of variables, including, for example: a radial width of material b; mean (or average) diameter Dm; deflection f; free height H; inside diameter I.D.; length, overall linear L; number of waves (per turn) N; an outside diameter O.D.; thickness of material t, work height W.H.; and a number of turns Z.

As shown in FIG. 4, exemplary crest-to crest wave spring 120″ includes four turns (i.e., Z=4) with three waves per turn (i.e., N=3). In contrast, exemplary crest-to crest wave spring 120′″includes three turns (i.e., Z=3) with three waves per turn (i.e., N=3). As noted above, while the invention has been described as having a crest-to crest wave spring 120 that includes two turns (i.e., Z=2) with four waves per turn (i.e., N=4), the invention contemplates crest-to crest wave springs having more or less than two turns, and/or more or less than four waves per turn.

While the invention has been described with reference to specific embodiments, those skilled in the art will understand that various changes may be made and equivalents may be substituted for elements thereof without departing from the true spirit and scope of the invention. In addition, modifications may be made without departing from the essential teachings of the invention.

For example, while the invention is described in the context of a thermal spray combustion gun, the invention contemplates utilization of the spring in other spray guns, for example, plasma spray guns and arc spray guns, amongst other contemplated spray guns.

What is claimed is:

1. A thermal spray combustion gun comprising:
a burner assembly;
a combustion chamber assembly;
a middle gun body; and
a spring,
wherein the spring is structured and arranged to exert a spring force that maintains a first metal-to-metal seal between the burner assembly and the combustion chamber assembly, and maintains a second metal-to-metal seal between the combustion chamber assembly and the middle gun body.

2. The thermal spray combustion gun of claim I, further comprising a gun body subassembly having a spring seat, wherein the spring is structured and arranged within the spring seat and in contact with the burner assembly.

3. The thermal spray combustion gun of claim I, wherein the burner assembly is arranged adjacent to the combustion chamber assembly at a first end of the combustion chamber assembly, and wherein the middle gun body is arranged adjacent to the combustion chamber assembly at a second end of the combustion chamber assembly.

4. The thermal spray combustion gun of claim 1, wherein the spring is structured and arranged to exert the spring force on the burner assembly.)

5. The thermal spray combustion gun of claim 1, wherein the spring comprises a compression spring.

6. The thermal spray combustion gun of claim 1, wherein the spring comprises a crest-to crest wave spring.

7. The thermal spray combustion gun of claim 1, wherein the burner assembly, the combustion chamber, and the middle gun body are structured and arranged having respective manufacturing tolerances such that a gap is provided at a spring location in which the spring is arranged.

8. The thermal spray combustion gun of claim 1, wherein the spring is structured and arranged to exert the spring force in an axial direction against the burner assembly, which urges the burner assembly towards a front of the thermal spray combustion gun to maintain the first metal-to-metal seal between the burner assembly and the combustion chamber assembly at one or more contact surfaces.

9. The thermal spray combustion gun of claim 8, wherein through contact of the burner assembly with the combustion chamber assembly at the one or more contact surfaces, the spring force is transmitted in the axial direction through the combustion chamber assembly, to maintain the combustion chamber assembly in contact with the middle gun body at one or more second contact surfaces to maintain the second metal-to-metal seal between the combustion chamber assembly and middle gun body at the one or more second contact surfaces.

10. The thermal spray combustion gun of claim 1, wherein the first metal-to-metal seal between the burner assembly and the combustion chamber assembly is operable to prevent gas from escaping from a back end of the combustion chamber assembly at the one or more contact surfaces.

11. The thermal spray combustion gun of claim 1, wherein the second metal-to-metal seal between the combustion chamber assembly and the middle gun body is operable to prevent gas from escaping from a front end of the combustion chamber assembly at the one or more second contact surfaces.

12. The thermal spray combustion gun of claim 1, wherein the burner assembly, the combustion chamber assembly and the middle gun body each comprise a metal.

13. The thermal spray combustion gun of claim 12, wherein the metal comprises copper.

14. The thermal spray combustion gun of claim 1, wherein the spring comprises a stainless steel.

15. The thermal spray combustion gun of claim 1, wherein the spring comprises a crest-to crest wave compression spring having two turns.

16. The thermal spray combustion gun of claim 1, wherein the spring comprises a crest-to crest wave compression spring having four waves per turn.

17. A method of assembling a thermal spray combustion gun, the thermal spray combustion gun comprising: a burner assembly, a combustion chamber assembly; a middle gun body; a gun body subassembly having a spring seat; and a spring, the method comprising:
arranging the spring in the spring seat;
arranging the burner assembly in the gun body subassembly in contact with the spring;
arranging the combustion chamber assembly in the gun body subassembly in contact with the burner assembly; and
attaching the middle gun body to the gun body subassembly, such that the middle gun body is in contact with the combustion chamber assembly,
wherein the spring is structured and arranged to exert a spring force that maintains a first metal-to-metal seal between the burner assembly and the combustion chamber assembly, and maintains a second metal-to-metal seal between the combustion chamber assembly and the middle gun body.

18. The method of assembling the thermal spray combustion gun of claim 17, wherein the spring comprises a crest-to crest wave compression spring.

19. The method of assembling the thermal spray combustion gun of claim 17, wherein the spring is structured and arranged to exert the spring force in an axial direction against the burner assembly, which urges the burner assembly towards a front of the thermal spray combustion gun to maintain the first metal-to-metal seal between the burner assembly and the combustion chamber assembly at one or more contact surfaces.

20. The method of assembling the thermal spray combustion gun of claim 19, wherein through the contact of the burner assembly with the combustion chamber assembly at the one or more contact surfaces, the spring force is transmitted through the combustion chamber assembly, and maintains the combustion chamber assembly in contact with the middle gun body at one or more second contact surfaces to provide the second metal-to-metal seal between the combustion chamber assembly and middle gun body at the one or more second contact surfaces.
